(19) United States
(12) Patent Application Publication
(10) Pub. No.: US 2025/0237026 A1
(43) Pub. Date: Jul. 24, 2025

(54) WORKING MACHINE AND ATTACHMENT

(71) Applicant: MAKITA CORPORATION, Anjo-shi (JP)

(72) Inventors: Makoto TSURUHISA, Anjo-shi (JP); Yoshinari Kikuchi, Anjo-shi (JP)

(73) Assignee: MAKITA CORPORATION, Anjo-shi (JP)

(21) Appl. No.: 19/018,059

(22) Filed: Jan. 13, 2025

(30) Foreign Application Priority Data
Jan. 24, 2024 (JP) 2024-008646

(51) Int. Cl. E01H 5/09

(52) U.S. Cl. CPC E01H 5/098

(57) ABSTRACT

The working machine may include an operation rod, a rear unit and a front unit. The front unit may include a front housing, a first member, a first shaft that is rotatable and supported by the first member via a first bearing, a working member configured to work by rotation of the first shaft, and a transmission unit configured to rotate the first shaft when the prime mover operates. The transmission unit may include a second shaft supported by the first member via a second bearing, a first pulley fixed to the first shaft and configured to rotate about a first pulley rotation axis, a second pulley fixed to the second shaft and configured to rotate about a second pulley rotation axis substantially parallel to the first pulley rotation axis, and a belt connecting the first pulley and the second pulley.

### REFERENCE TO RELATED APPLICATIONS

This application claims priority from Japanese Patent Application No. 2024-008646 filed on Jan. 24, 2024. The entire content of the priority application is incorporated herein by reference.

### BACKGROUND ART

Chinese Patent Application Publication No. 114481930 describes a working machine. The working machine includes: an operation rod, a rear unit disposed at a rear end of the operation rod and including a prime mover; and a front unit disposed at a front end of the operation rod. The front unit includes: a front housing; a first member and a second member that are disposed within the front housing and fixed to the front housing; a first shaft that is rotatable and supported by the first member via a first bearing, a working member configured to work by rotation of the first shaft; and a transmission unit configured to rotate the working member when the prime mover operates. The transmission unit includes: a second shaft supported by the second member via a second bearing; a first pulley fixed to the first shaft and configured to rotate about a first pulley rotation axis; a second pulley fixed to the second shaft and configured to rotate about a second pulley rotation axis substantially parallel to the first pulley rotation axis; a belt connecting the first pulley and the second pulley; and a tensioner configured to adjust tension of the belt.

### SUMMARY

In the above-described working machine, the first shaft is supported by the first member and the second shaft is supported by the second member different from the first member. In this configuration, the position of the second shaft relative to the first shaft changes. Due to this, the tension of the belt needs to be adjusted by the tensioner. The present teachings provide an art which allows to omit a tensioner.

The present teachings disclose a working machine. The working machine may comprise an operation rod extending in a front-rear direction; a rear unit disposed at a rear end of the operation rod and comprising a prime mover; and a front unit disposed at a front end of the operation rod. The front unit may comprise: a front housing; a first member disposed within the front housing and fixed to the front housing; a first shaft that is rotatable and supported by the first member via a first bearing; a working member configured to work by rotation of the first shaft; and a transmission unit configured to rotate the first shaft when the prime mover operates. The transmission unit may comprise: a second shaft supported by the first member via a second bearing; a first pulley fixed to the first shaft and configured to rotate about a first pulley rotation axis; a second pulley fixed to the second shaft and configured to rotate about a second pulley rotation axis substantially parallel to the first pulley rotation axis; and a belt connecting the first pulley and the second pulley.

According to the configuration, the first shaft and the second shaft are both supported by the first member. Due to this, the position of the second shaft relative to the first shaft can be suppressed from changing. Due to this, suitable tension can be applied to the belt when the belt is connected to the first pulley and the second pulley. Due to this, the tensioner can be omitted.

The present teachings disclose an attachment. The attachment may be attached to a base unit including a rear operation rod extending in a front-rear direction and a rear unit disposed at a rear end of the rear operation rod and including a prime mover. The attachment may comprise: a front operation rod extending in the front-rear direction and attached to the rear operation rod; and a front unit disposed at a front end of the front operation rod. The front unit may comprise: a front housing; a first member disposed within the front housing and fixed to the front housing; a first shaft that is rotatable and supported by the first member via a first bearing; a working member configured to work by rotation of the first shaft; and a transmission unit configured to rotate the first shaft when the prime mover operates. The transmission unit may comprise: a second shaft supported by the first member via a second bearing; a first pulley fixed to the first shaft and configured to rotate about a first pulley rotation axis; a second pulley fixed to the second shaft and configured to rotate about a second pulley rotation axis substantially parallel to the first pulley rotation axis; and a belt connecting the first pulley and the second pulley.

According to the above configuration, the same effect as the above working machine brings can be achieved.

### BRIEF DESCRIPTION OF DRAWINGS

FIG. 1 shows a perspective view of a working machine 2 according to an embodiment.

FIG. 2 shows a left side view of a base unit 4 according to the embodiment, seeing a motor accommodating portion 40 and its surroundings with a rear left housing 38 removed.

FIG. 3 shows a cross-sectional view of an attachment unit 18 and its surroundings of the working machine 2 according to the embodiment.

FIG. 4 shows a perspective view of a rear operation rod 10, the attachment unit 18, and a front operation rod 60 according to the embodiment.

FIG. 5 shows a perspective view of a front unit 64 of an attachment 6 according to the embodiment and its surroundings.

FIG. 6 shows a perspective view of a front rod shaft 62, a transmission unit 76, a working shaft 104, and a first member 112 according to the embodiment.

FIG. 7 shows a cross-sectional view of a second member 114 of the attachment 6 according to the embodiment and its surroundings.

FIG. 8 shows a cross-sectional view of the first member 112 of the attachment 6 according to the embodiment and its surroundings.

FIG. 9 shows a cross-sectional view of a right bearing 108 of the attachment 6 according to the embodiment and its surroundings.

FIG. 10 shows a perspective view of direction changing members 160 and an adjuster 162 according to the embodiment.

FIG. 11 shows an exploded perspective view of the direction changing member 160, a gear 180, and a positioning member 182 according to the embodiment.

FIG. 12 shows a cross-sectional view of the adjuster 162 and its surroundings when a handle 184 is not pulled in the attachment 6 according to the embodiment.

FIG. 13 shows an exploded perspective view of the gear 180 and the positioning member 182 according to the embodiment.

FIG. 14 shows a cross-sectional view of the direction changing member 160 and the adjuster 162 according to the embodiment.

FIG. 15 shows a rear view of a positioning rib 230 of a first front housing 82 according to the embodiment and its surroundings.

FIG. 16 shows a cross-sectional view of the adjuster 162 and its surroundings when the handle 184 is pulled in the attachment 6 according to the embodiment.

### DESCRIPTION

Representative, non-limiting examples of the present disclosure will now be described in further detail with reference to the attached drawings. This detailed description is merely intended to teach a person of skill in the art further details for practicing aspects of the present teachings and is not intended to limit the scope of the present disclosure. Furthermore, each of the additional features and teachings disclosed below may be utilized separately or in conjunction with other features and teachings to provide improved working machines, attachments, as well as methods for using and manufacturing the same.

Moreover, combinations of features and steps disclosed in the following detailed description may not be necessary to practice the present disclosure in the broadest sense, and are instead taught merely to particularly describe representative examples of the present disclosure. Furthermore, various features of below-described representative examples, as well as the various independent and dependent claims, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

The disclosure discloses a working machine. The working machine may comprise an operation rod extending in a front-rear direction; a rear unit disposed at a rear end of the operation rod and comprising a prime mover; and a front unit disposed at a front end of the operation rod. The front unit may comprise: a front housing; a first member disposed within the front housing and fixed to the front housing; a first shaft that is rotatable and supported by the first member via a first bearing; a working member configured to work by rotation of the first shaft; and a transmission unit configured to rotate the first shaft when the prime mover operates. The transmission unit may comprise: a second shaft supported by the first member via a second bearing; a first pulley fixed to the first shaft and configured to rotate about a first pulley rotation axis; a second pulley fixed to the second shaft and configured to rotate about a second pulley rotation axis substantially parallel to the first pulley rotation axis; and a belt connecting the first pulley and the second pulley.

In one or more embodiments, the first shaft may be substantially parallel to the second shaft.

According to the above configuration, configurations of the first shaft and the second shaft can be simplified.

In one or more embodiments, the working machine may further comprise a third shaft substantially perpendicular to the second shaft and extending in the front-rear direction. The third shaft may be configured to rotate the second shaft when the prime mover operates.

According to the above configuration, a rotation axis of the first shaft is substantially perpendicular to the operation rod. Due to this, workability by the working machine can be improved.

In one or more embodiments, the front unit may comprise: a second member fixed to the first member and surrounding the second shaft; and a third member fixed to the second member and the operation rod and surrounding the third shaft. The second shaft may be supported by the third member via a third bearing.

According to the above configuration, the position of the second shaft relative to the first shaft can further be suppressed from being changed.

In one or more embodiments, one end of the first shaft may be supported by the front housing.

According to the above configuration, as compared to a configuration where the one end of the first shaft is not supported, vibration of the first shaft caused by rotation of the first shaft can be suppressed.

In one or more embodiments, the first member may be constituted of metal.

According to the above configuration, as compared to a configuration where the first member is constituted of a resin material, the first member can be suppressed from being deformed. Due to this, the position of the second shaft relative to the first shaft can be farther suppressed from being changed.

### Embodiment

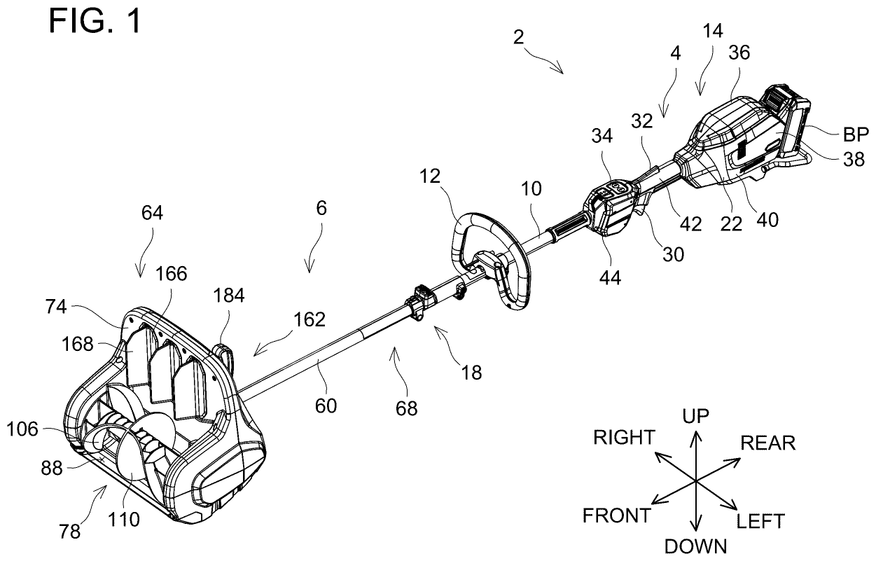

As shown in FIG. 1, the working machine 2 is a pole-type working machine. The working machine 2 is a snow remover configured to throw snow off the ground. The working machine 2 comprises a base unit 4 and an attachment 6. The attachment 6 is configured to be detachably attached to the base unit 4. The base unit 4 is configured to have selectively one of the attachment 6 and another type of attachment different from the attachment 6 attached thereto.

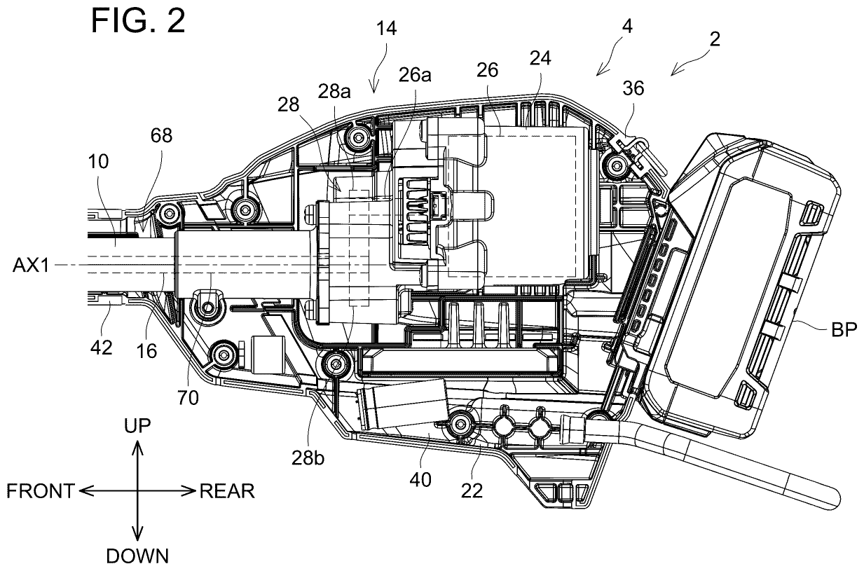

The base unit 4 comprises a rear operation rod 10, a loop handle 12, a rear unit 14, a rear rod shaft 16 (see FIG. 2), and an attachment unit 18.

The rear operation rod 10 has an elongated, hollow rod shape. Hereafter, a direction in which the rear operation rod 10 extends will be referred to as a front-rear direction, a direction perpendicular to the front-rear direction will be referred to as a left-right direction, and a direction perpendicular to the front-rear and left-right directions will be referred to as an up-down direction.

The loop handle 12 is fixed to the rear operation rod 10. The loop handle 12 is grasped by a user during work using the working machine 2.

The rear unit 14 is fixed to a rear end of the rear operation rod 10. The rear unit 14 comprises a rear housing 22, a motor housing 24 (see FIG. 2), a motor 26 (see FIG. 2), a gear unit 28 (see FIG. 2), a trigger 30, a shark fin 32, and a main power switch 34.

The rear housing 22 comprises a rear right housing 36 defining an outer shape of a right half surface of the rear housing 22 and a rear left housing 38 defining an outer shape of a left half surface of the rear housing 22. The rear housing 22 comprises a motor accommodating portion 40, a grip portion 42, and a switch portion 44.

As shown in FIG. 2, a battery pack BP can be detachably attached to a rear surface of the motor accommodating portion 40. The battery pack BP slides on the rear surface of the motor accommodating portion 40. A sliding direction of the battery pack BP is inclined relative to the up-down direction. The battery pack BP comprises a rechargeable secondary battery, e.g., lithium-ion battery. As shown in FIG. 1, the grip portion 42 is disposed frontward of the motor accommodating portion 40. The grip portion 42 is grasped by a hand opposite from a hand grasping the loop handle 12 during a work using the working machine 2. The switch portion 44 is disposed frontward of the grip portion 42.

As shown in FIG. 2, the motor housing 24, the motor 26, and the gear unit 28 are disposed within the motor accommodating portion 40. In FIG. 2, the motor 26, the gear unit 28, and the rear rod shaft 16 are shown with broken lines. The motor 26 is disposed within the motor housing 24. The motor 26 is an example for a prime mover. The motor 26 is for example a brushless motor.

The gear unit 28 comprises a first gear 28a fixed to a front end of a motor shaft 26a of the motor 26 and a second gear 28b fixed to a rear end of the rear rod shaft 16. The first gear 28a and the second gear 28b are meshed with each other. The gear unit 28 functions as a speed reduction mechanism. When the motor shaft 26a rotates, the first gear 28a and the second gear 28b rotate, by which the rear rod shaft 16 rotates about a rear rod shaft rotation axis AX1. The rear rod shaft rotation axis AX1 extends in the front-rear direction. The rear rod shaft rotation axis AX1 is offset from a rotation axis of the motor shaft 26a in the up-down direction. The rear rod shaft 16 is rotatably supported by the rear operation rod 10 within the rear operation rod 10.

As shown in FIG. 1, the trigger 30 is attached to a lower part of the switch portion 44 such that the trigger 30 can be pulled in. The shark fin 32 is attached to an upper part of the grip portion 42 such that the shark fin 32 can be pushed in. With the shark fin 32 pushed in, the user can pull the trigger 30 in. Without the shark fin 32 pushed in, the user cannot pull the trigger 30 in. The main power switch 34 is arranged on an upper part of the switch portion 44. The main power switch 34 is configured to switch between an on/off state of the working machine 2. When, with the working machine 2 in the on state, the shark fin 32 is pushed in by a palm of the user grasping the grip portion 42 and the trigger 30 is pulled in by finger(s) of the user grasping the grip portion 42, the motor 26 (see FIG. 2) rotates.

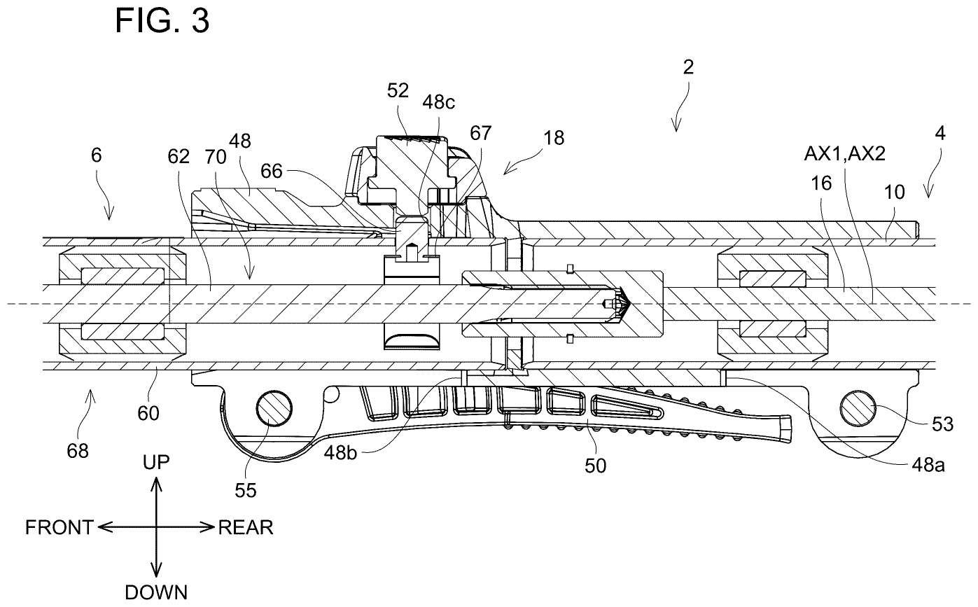

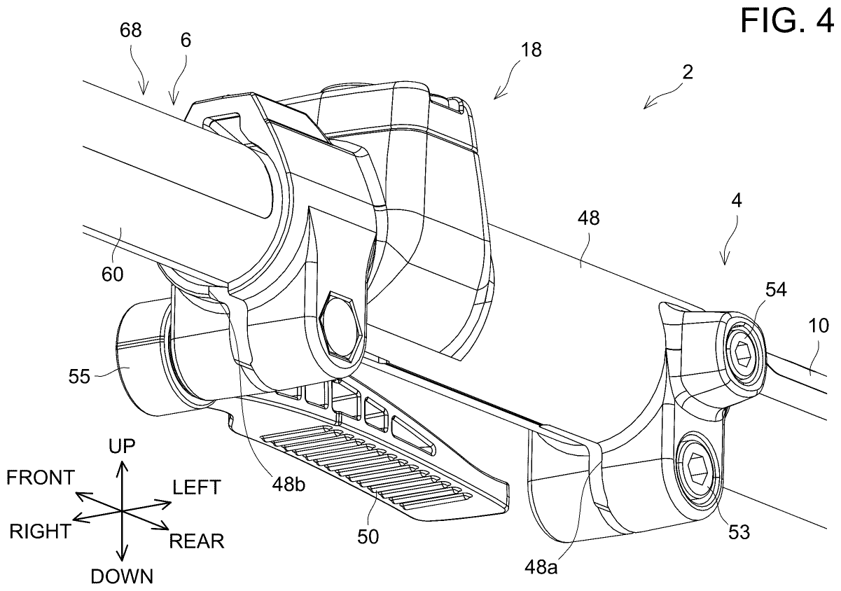

As shown in FIG. 3, the attachment unit 18 comprises a tubular member 48, a lever 50, and a push-in member 52. The tubular member 48 has a substantially cylindrical shape extending in the front-rear direction. The tubular member 48 supports the push-in member 52 such that the push-in member 52 can be pushed in. As shown in FIG. 4, the tubular member 48 includes a rear notch 48a extending frontward from a rear end of the tubular member 48 and a front notch 48b extending rearward from a front end of the tubular member 48. A front end of the rear rod shaft 16 is inserted into the tubular member 48 from the rear side. The front end of the rear rod shaft 16 is fixed to the tubular member 48 by a width of the rear notch 48a in the left-right direction being narrowed by a first rear bolt 53. The rear rod shaft 16 can be suppressed from rotating relative to the tubular member 48 by a second rear bolt 54 penetrating the rear rod shaft 16.

The lever 50 is supported so as to be pivotable by the tubular member 48 via a front bolt 55. When the lever 50 pivots to be pushed down, the front bolt 55 widens a width of the front notch 48b in the left-right direction. When the lever 50 pivots so as to be pushed to be lifted up, the front bolt 55 narrows the width of the front notch 48b in the left-right direction.

As shown in FIG. 1, the attachment 6 comprises the front operation rod 60, a front rod shaft 62 (see FIG. 3), and a front unit 64.

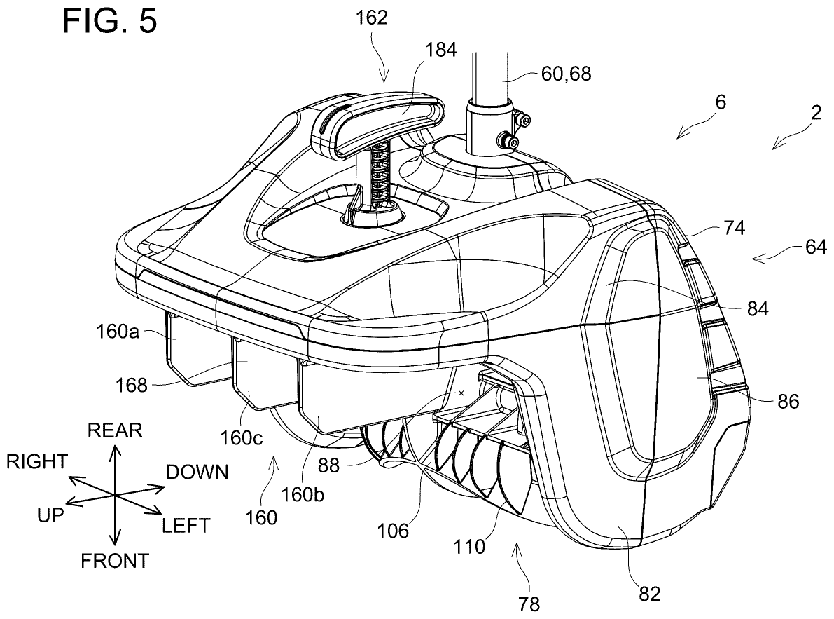

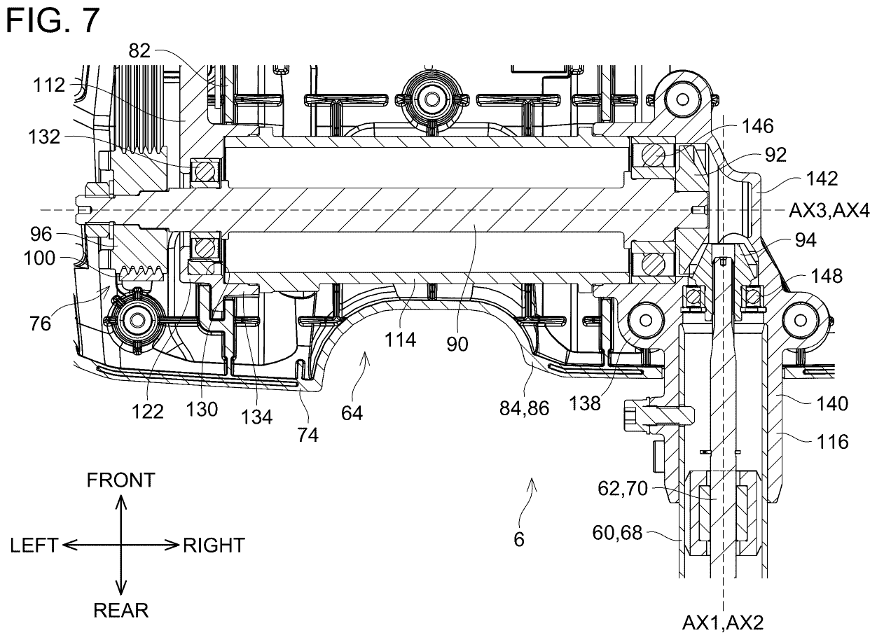

The front operation rod 60 has an elongated, hollow rod shape. The front operation rod 60 extends in the front-rear direction. As shown in FIG. 5, the front operation rod 60 is fixed to the front unit 64 via a third member 116 (see FIG. 7) described later. As shown in FIG. 3, a rear end of the front operation rod 60 is inserted into the tubular member 48 from the front side. When the lever 50 pivots so as to be pushed to be lifted up with the rear end of the front operation rod 60 inserted into the tubular member 48, the width of the front notch 48b in the left-right direction narrows, by which the rear end of the front operation rod 60 is fixed to the tubular member 48. Due to this, the front operation rod 60 is attached to the rear operation rod 10 via the attachment unit 18.

An engagement pin 66 is slidably attached to the rear end of the front operation rod 60. When the front operation rod 60 is inserted into the tubular member 48 and also the push-in member 52 is not pushed in, the engagement pin 66 is inserted into a through-hole 48c of the tubular member 48 by a biasing force of a leaf spring 67. Due to this, the front operation rod 60 can be suppressed from rotating relative to the tubular member 48. When the front operation rod 60 is to be detached from the rear operation rod 10, the user pivots the lever 50 so as to be pushed down. Next, the user pushes in the push-in member 52. The engagement pin 66 comes out of the through-hole 48c by being pushed by the push-in member 52. Lastly, the user pulls the front operation rod 60 from the tubular member 48. Hereafter, the front operation rod 60 and the rear operation rod 10 may be collectively referred to as an operation rod 68.

The front rod shaft 62 is rotatably supported by the front operation rod 60 within the front operation rod 60. The front rod shaft 62 fits into the rear rod shaft 16 when the front operation rod 60 is attached to the rear operation rod 10 via the attachment unit 18. The front rod shaft 62 rotates about a front rod shaft rotation axis AX2 integrally with the rear rod shaft 16. The front rod shaft rotation axis AX2 extends in the front-rear direction. The front rod shaft rotation axis AX2 is coaxial with the rear rod shaft rotation axis AX1. Hereafter, the front rod shaft 62 and the rear rod shaft 16 may be collectively referred to as a rod shaft 70.

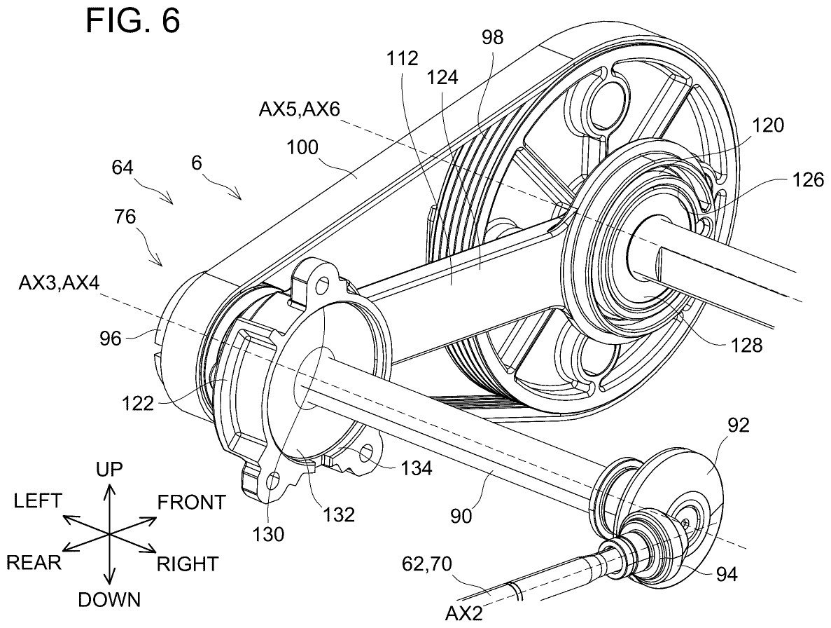

As shown in FIG. 5, the front unit 64 is fixed to a front end of the front operation rod 60. The front unit 64 comprises a front housing 74, a transmission unit 76 (see FIG. 6), and a working portion 78.

The front housing 74 is constituted of a resin material, for example. The front housing 74 is for example, nylon. The front housing 74 comprises a first front housing 82, a second front housing 84, and a third front housing 86. The first front housing 82 defines an outer shape of a front upper part of the front housing 74. The second front housing 84 defines an outer shape of a rear upper part of the front housing 74. The second front housing 84 is fixed to a rear part of the first front housing 82. The third front housing 86 defines an outer shape of a lower part of the front housing 74. The third front housing 86 is fixed to a lower part of the first front housing 82 and a lower part of the second front housing 84. The first front housing 82 and the third front housing 86 define a working space 88. The working space 88 is located outside the front housing 74.

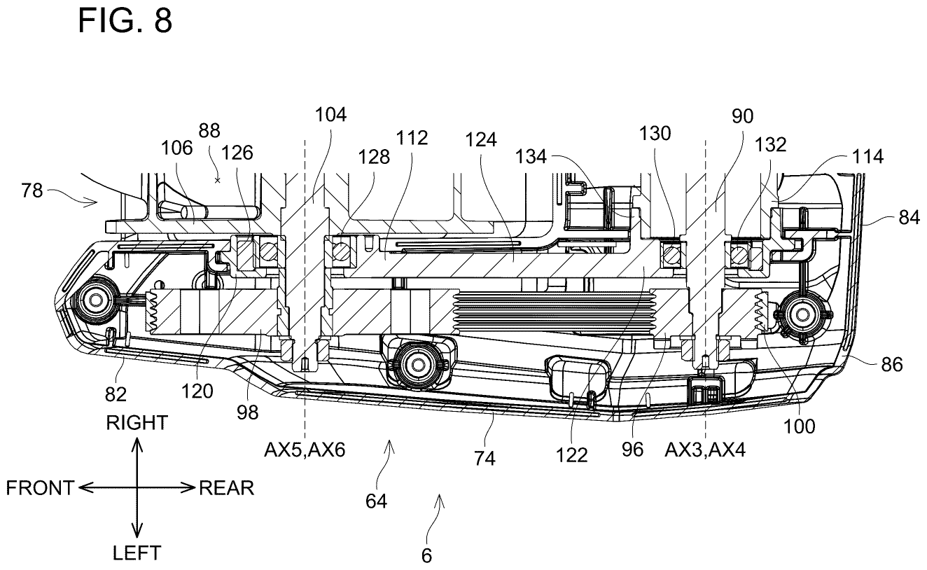

As shown in FIG. 6, a transmission unit 76 comprises a transmission shaft 90, a first bevel gear 92, a second bevel gear 94, a rear pulley 96, a front pulley 98, and a belt 100. As shown in FIGS. 7 and 8, the transmission shaft 90, the first bevel gear 92, the second bevel gear 94, the rear pulley 96, the front pulley 98, and the belt 100 are arranged within the front housing 74.

As shown in FIG. 7, the transmission shaft 90 extends in the left-right direction. The transmission shaft 90 is substantially perpendicular to the front rod shaft 62. The first bevel gear 92 is meshed with the second bevel gear 94. The transmission shaft 90 is connected to the front rod shaft 62 via the first bevel gear 92 and the second bevel gear 94. The first bevel gear 92 and the second bevel gear 94 function as a speed reduction mechanism. The first bevel gear 92 is fixed to a right end of the transmission shaft 90. The second bevel gear 94 is fixed to a front end of the front rod shaft 62. When the front rod shaft 62 rotates, the first bevel gear 92 and the second bevel gear 94 accordingly rotate, by which the transmission shaft 90 rotates about a transmission shaft rotation axis AX3. The transmission shaft rotation axis AX3 is substantially perpendicular to the front rod shaft rotation axis AX2.

The rear pulley 96 is fixed to a left end of the transmission shaft 90. The rear pulley 96 rotates about a rear pulley rotation axis AX4 integrally with the transmission shaft 90. The rear pulley rotation axis AX4 extends in the left-right direction. The rear pulley rotation axis AX4 is coaxial with the transmission shaft rotation axis AX3.

As shown in FIG. 8, the front pulley 98 is located frontward of the rear pulley 96. A diameter of the front pulley 98 is larger than a diameter of the rear pulley 96.

The belt 100 is bridged onto the rear pulley 96 and the front pulley 98. The belt 100 connects the rear pulley 96 and the front pulley 98. Rotation of the rear pulley 96 is transmitted to the front pulley 98 via the belt 100. Due to this, the front pulley 98 rotates about a front pulley rotation axis AX5. The front pulley rotation axis AX5 extends in the left-right direction. The front pulley rotation axis AX5 is substantially parallel to the rear pulley rotation axis AX4. The rear pulley 96, the front pulley 98, and the belt 100 function as a speed reduction mechanism.

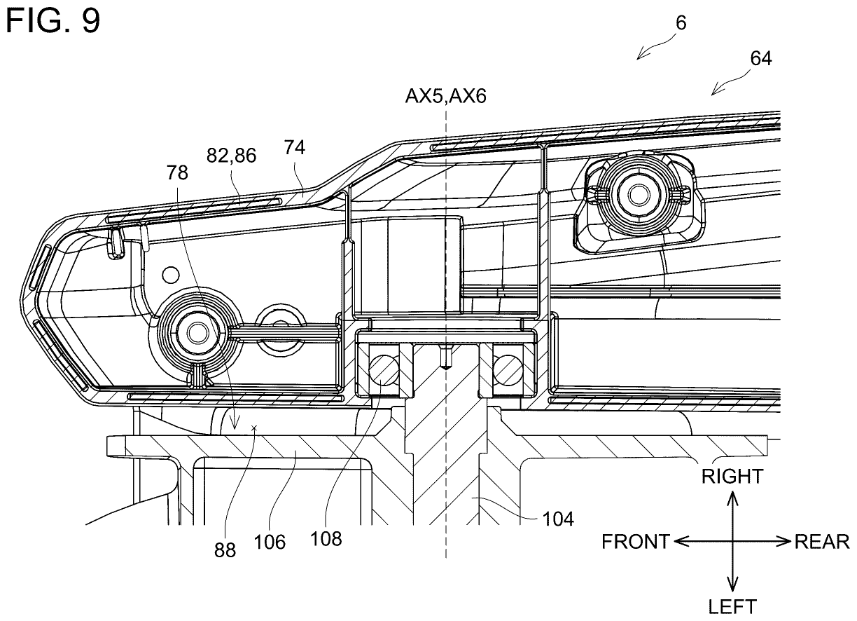

The working portion 78 comprises a working shaft 104 and a working member 106 (see FIG. 5). The working shaft 104 is arranged by striding over a space inside the front housing 74 and the working space 88. A left end of the working shaft 104 is fixed to the front pulley 98. The working shaft 104 extends in the left-right direction. The working shaft 104 is substantially parallel to the transmission shaft 90. The working shaft 104 rotates about a working shaft rotation axis AX6 integrally with the front pulley 98. The working shaft rotation axis AX6 extends in the left-right direction. The working shaft rotation axis AX6 is coaxial with the front pulley rotation axis AX5. As shown in FIG. 9, a right end of the working shaft 104 is supported by the first front housing 82 and the third front housing 86 via the right bearing 108 such that the working shaft 104 is rotatable. Due to this, vibration caused by the rotation of the working shaft 104 can be suppressed as compared to a configuration where the right end of the working shaft 104 is not supported such that the working shaft 104 is rotatable.

The working shaft 104 is inserted into the working member 106. The working member 106 is for example a paddle. The working member 106 is separate from the working shaft 104. The working member 106 fits into the working shaft 104. The working member 106 rotates integrally with the working shaft 104. As shown in FIG. 5, the working member 106 comprises a plurality of fins 110. When the working member 106 rotates, the plurality of fins 110 throws snow off the ground.

As shown in FIGS. 7 and 8, the front unit 64 further comprises a first member 112, a second member 114, and the third member 116.

The first member 112 is disposed within the front housing 74. As shown in FIG. 6, the first member 112 extends in the front-rear direction. The first member 112 has a plate shape. The first member 112 is constituted of, for example a metal material. The first member 112 is aluminum, for example. A hardness of the first member 112 is greater than a hardness of the front housing 74. The first member 112 comprises a first front support portion 120, a first rear support portion 122, and a first connecting portion 124 connecting the first front support portion 120 and the first rear support portion 122.

As shown in FIG. 8, the first front support portion 120 is located to the right of the front pulley 98. The first front support portion 120 is sandwiched between the first front housing 82 and the third front housing 86 in the up-down direction, by which the first front support portion 120 is supported by the first front housing 82 and the third front housing 86. The first front support portion 120 has a front through-hole 126. The front through-hole 126 penetrates the first front support portion 120 in the left-right direction. The working shaft 104 penetrates the front through-hole 126. The working shaft 104 is rotatably supported by the first front support portion 120 via a first bearing 128 within the front through-hole 126.

The first rear support portion 122 is disposed to the right of the rear pulley 96. The first rear support portion 122 is disposed behind the first front support portion 120. The first rear support portion 122 is fixed to each of the second front housing 84 and the third front housing 86. The first rear support portion 122 has a rear through-hole 130. The rear through-hole 130 penetrates the first rear support portion 122 in the left-right direction. The transmission shaft 90 penetrates the rear through-hole 130. The transmission shaft 90 is rotatably supported by the first rear support portion 122 via a second bearing 132 within the rear through-hole 130.

The first rear support portion 122 comprises a cylindrical rib 134. The cylindrical rib 134 is defined on a right surface of the first rear support portion 122. The cylindrical rib 134 has a substantially cylindrical shape. The cylindrical rib 134 surrounds an entire periphery of the rear through-hole 130.

As shown in FIG. 7, the second member 114 is disposed within the front housing 74. The second member 114 extends in the left-right direction. The second member 114 has a substantially cylindrical shape. The second member 114 is constituted of, for example a resin material. The second member 114 is nylon, for example. The material of the second member 114 is the same as, for example, the material of the front housing 74. A hardness of the second member 114 is substantially the same as a hardness of the front housing 74. The material of the second member 114 is different from, for example, the material of the first member 112. The hardness of the second member 114 is smaller than a hardness of the first member 112. The second member 114 is sandwiched between the second front housing 84 and the third front housing 86 in the up-down direction, by which the second member 114 is supported by the second front housing 84 and the third front housing 86. The second member 114 surrounds the transmission shaft 90. An inner peripheral surface of the second member 114 is apart from an outer peripheral surface of the transmission shaft 90. The transmission shaft 90 penetrates the second member 114. The second member 114 is disposed to the right of the first rear support portion 122. The second member 114 is fixed to the first rear support portion 122. A left end of the second member 114 is inserted into the cylindrical rib 134.

The third member 116 has a substantial L shape. The third member 116 is constituted of, for example, a metal material. The third member 116 is for example, aluminum. A material of the third member 116 is different from the materials of the front housing 74 and the second member 114. A hardness of the third member 116 is greater than both of the hardness of the front housing 74 and the hardness of the second member 114. The material of the third member 116 is the same as, for example, the material of the first member 112. The hardness of the third member 116 is substantially the same as the hardness of the first member 112. The third member 116 is sandwiched between the second front housing 84 and the third front housing 86 in the up-down direction. The third member 116 is fixed to each of the second front housing 84 and the third front housing 86. The third member 116 comprises a third front support portion 138, a third rear support portion 140, and a third connecting portion 142 connecting the third front support portion 138 and the third rear support portion 140.

The third front support portion 138 is disposed within the front housing 74. The third front support portion 138 extends in the left-right direction. The third front support portion 138 has a substantially cylindrical shape. A right end of the second member 114 is inserted into the third front support portion 138. The second member 114 is sandwiched between the first rear support portion 122 and the third front support portion 138. The third front support portion 138 is fixed to the second member 114. The third front support portion 138 surrounds the transmission shaft 90. The transmission shaft 90 is inserted into the third front support portion 138. The transmission shaft 90 is rotatably supported by the third front support portion 138 via a third bearing 146 within the third front support portion 138. The third bearing 146 is disposed between the first bevel gear 92 and the second member 114.

The third rear support portion 140 is disposed by striding over inside and outside of the front housing 74. The third rear support portion 140 extends in the front-rear direction. A direction in which the third rear support portion 140 extends is inclined, for example, substantially perpendicular relative to a direction in which the third front support portion 138 extends. The third rear support portion 140 has a substantially cylindrical shape. The third rear support portion 140 surrounds the front rod shaft 62. The front end of the front rod shaft 62 is inserted into the third rear support portion 140. The front rod shaft 62 and the second bevel gear 94 are rotatably supported by the third rear support portion 140 via a fourth bearing 148 within the third rear support portion 140.

The third connecting portion 142 connects an interior space of the third front support portion 138 and an interior space of the third rear support portion 140. A part of the front rod shaft 62, a part of the first bevel gear 92, and a part of the second bevel gear 94 are disposed within the third connecting portion 142.

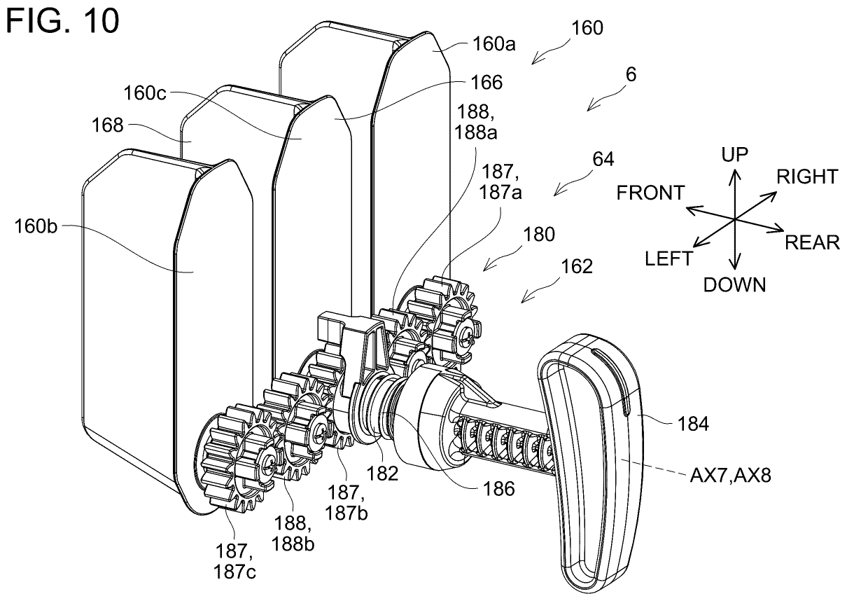

As shown in FIG. 10, the front unit 64 comprises a plurality of (three in the present embodiment) direction changing members 160 and an adjuster 162. Hereafter, among the three direction changing members 160, a rightmost direction changing member 160 may be referred to as a direction changing member 160a, a leftmost direction changing member 160 may be referred to as a left direction changing member 160b, and a direction changing member 160 between the right direction changing member 160a and the left direction changing member 160b may be referred to as a middle direction changing member 160c.

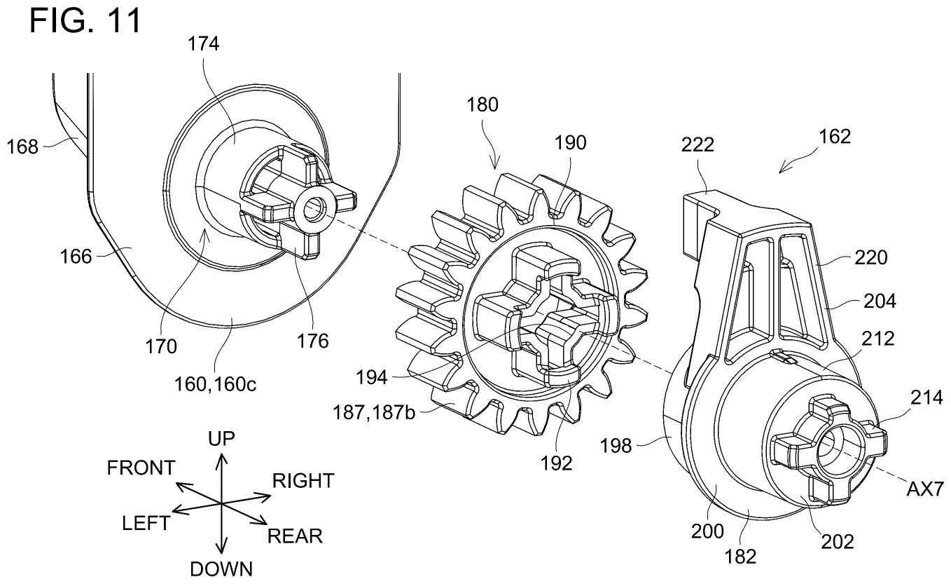

The direction changing members 160 are constituted of, for example, a resin material. An orientation of the direction changing members 160 is adjusted by the adjuster 162. The direction changing members 160 change a direction for throwing snow swept by the working member 106 (see FIG. 5). Each of the direction changing members 160 comprises a base portion 166, a fin portion 168, an engaging portion 170 (see FIG. 11). The base portion 166, the fin portion 168, and the engaging portion 170 are fabricated by integral molding.

The base portions 166 have a plate shape. As shown in FIG. 1, the base portions 166 are disposed in the working space 88. The base portions 166 are disposed along an outer surface of the first front housing 82.

The fin portions 168 are disposed in the working space 88. Each of the fin portions 168 is fixed to a corresponding one of the base portions 166. The fin portions 168 have a plate shape. The fin portions 168 are substantially perpendicular to the base portions 166. The fin portions 168 change the direction for throwing snow by guiding snow swept by the working member 106. When the orientation of the direction changing members 160 changes, orientations of the fin portions 168 change. When the fin portions 168 are disposed along a plane including the up-down direction and the front-rear direction, the fin portions 168 throws snow upward. Also, when the fin portions 168 are inclined relative to the plane including the up-down and front-rear directions such that upper ends of the fin portions 168 are located to the right of lower ends of the fin portions 168, the fin portions 168 throw snow in a right-and-upward direction. When the fin portions 168 are inclined relative to the plane including the up-down and front-rear directions such that the upper ends of the fin portions 168 are located to the left of the lower ends of the fin portions 168, the fin portions 168 throw snow in a left-and-upward direction.

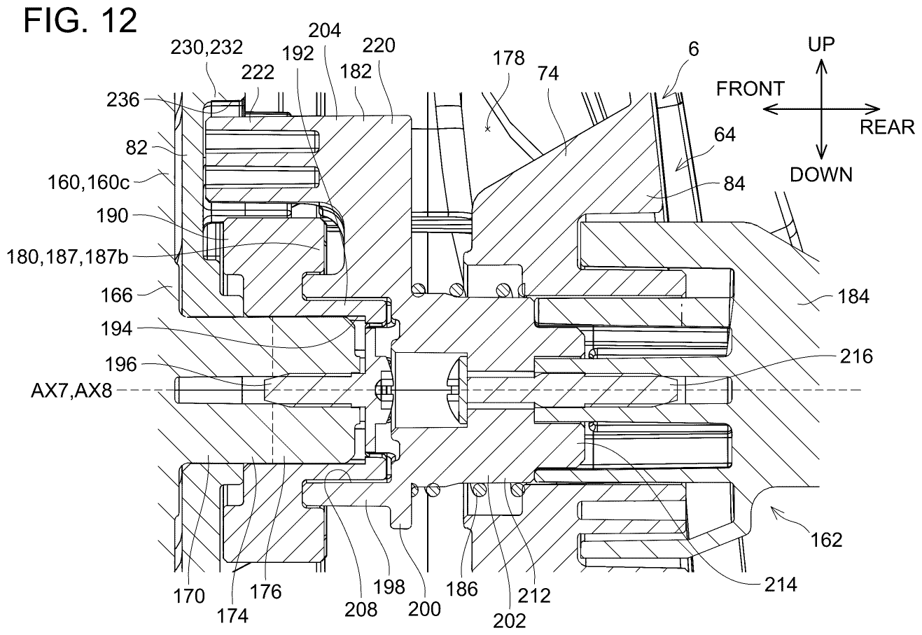

As shown in FIG. 11, each engaging portion 170 is fixed to the corresponding base portion 166. The engaging portion 170 is fixed to a surface of the base portion 166 opposite from a surface to which the fin portion 168 (see FIG. 10) is fixed. The engaging portion 170 projects from the base portion 166. The engaging portion 170 comprises a columnar portion 174 extending from the base portion 166 and a rib portion 176 extending from the columnar portion 174. The rib portion 176 has a cross shape. As shown in FIG. 12, the columnar portion 174 penetrates the first front housing 82. The rib portion 176 is disposed within the front housing 74. The rib portion 176 is disposed in a gear accommodating space 178 defined by the first front housing 82 and the second front housing 84. Here, in FIG. 12, a boundary between the columnar portion 174 and the rib portion 176 is illustrated with a broken line.

As shown in FIG. 10, the adjuster 162 comprises a plurality of (five in the present embodiment) gears 180, a positioning member 182, a handle 184, and a biasing member 186. As shown in FIG. 12, the plurality of gears 180, the positioning member 182, and the biasing member 186 are disposed in the gear accommodating space 178. The handle 184 is disposed outside the front housing 74.

The gears 180 are rotatably supported by the first front housing 82. As shown in FIG. 10, the gears 180 adjacent to each other are meshed with each other. The five gears 180 comprise a plurality of (three in the present embodiment) first gears 187 and one or more (two in the present embodiment) second gears 188.

Shapes of the three first gears 187 are the same. The first gears 187 are for example spur gears. Rotational centers of the three first gears 187 align in the left-right direction. A rotation axis of each first gear 187 is coaxial with a rotation axis of the corresponding direction changing member 160. The three first gears 187 are apart from each other in the left-right direction. The first gears 187 are fixed to the direction changing members 160. Hereafter, the first gear 187 fixed to the right direction changing member 160a will be referred to as a first gear 187a, the first gear 187 fixed to the middle direction changing member 160c will be referred to as a first gear 187b, and the first gear 187 fixed to the left direction changing member 160b will be referred to as a first gear 187c.

Shapes of the two second gears 188 are the same as each other. The shapes of the second gears 188 are the same as the shapes of the first gears 187. The second gears 188 are for example spur gears. A gear type of the second gears 188 is the same as a gear type of the first gears 187. The second gears 188 are not fixed to the direction changing members 160. Rotational centers of the two second gears 188 align in the left-right direction. The rotational centers of the three first gears 187 are aligned with rotational centers of the two second gears 188 in the left-right direction. Each second gear 188 is disposed between the two adjacent first gears 187. Each second gear 188 is meshed with the two adjacent first gears 187. Each second gear 188 transmits rotation of one of the two adjacent first gears 187 to another of the two adjacent first gears 187. Hereafter, the second gear 188 disposed between the first gear 187a and the first gear 187b will be referred to as a second gear 188a, and the second gear 188 disposed between the first gear 187b and the first gear 187c will be referred to as a second gear 188b.

When the gears 180 rotate, the first gears 187a, 187b, 187c rotate in a first rotational direction and the second gears 188a, 188b rotate in a second rotational direction opposite from the first rotational direction. Due to this, the three direction changing members 160 rotate in a same rotational direction, e.g., in the first rotational direction. A direction in which the direction changing members 160 rotate is the same as the direction in which the first gears 187 rotate. Also, a rotational speed of the first gears 187a, 187b, 187c is the same. Due to this, when the gears 180 rotate, the orientations of the three direction changing members 160 are the same. Due to this, the direction for throwing snow swept by the working member 106 (see FIG. 5) can be changed more easily.

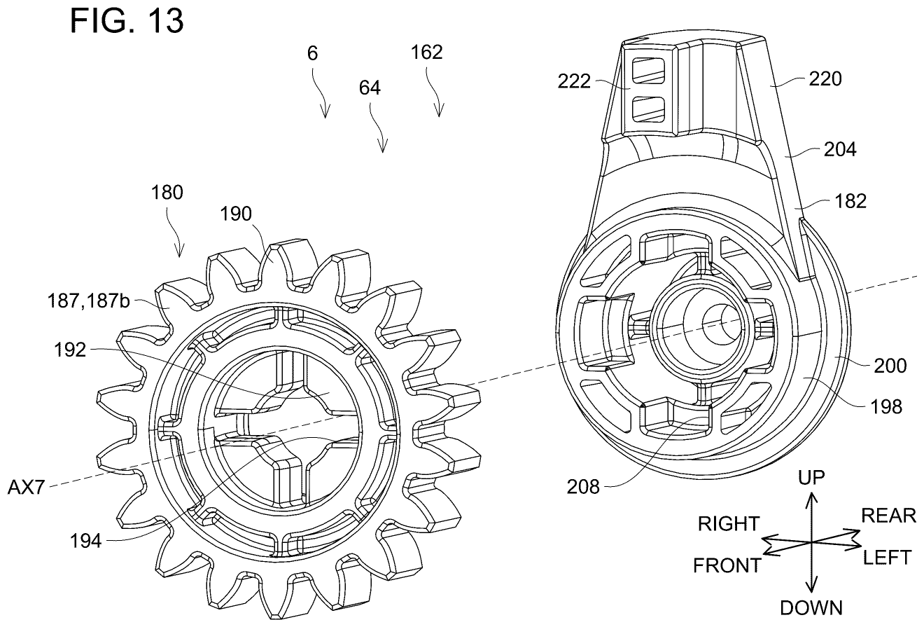

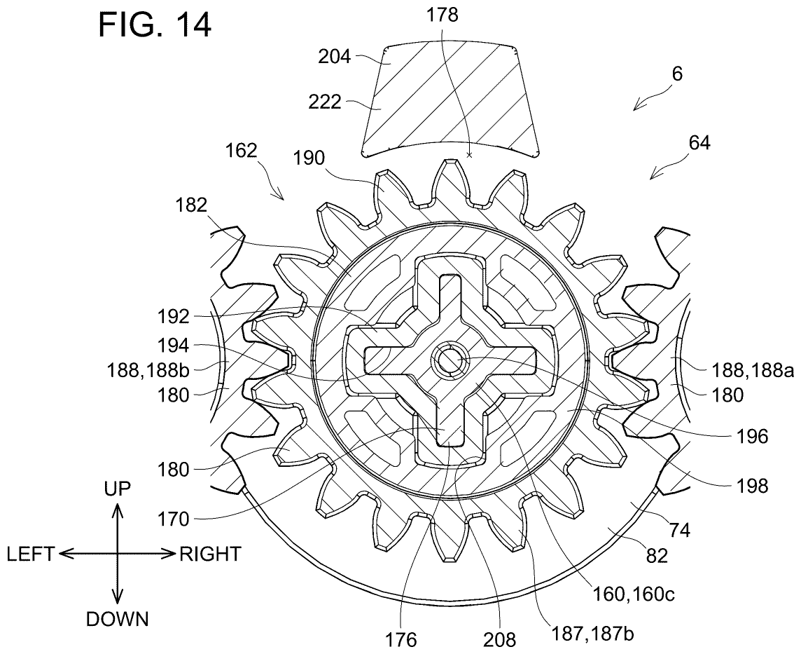

As shown in FIG. 11, each of the gears 180 comprises a gear portion 190 and a gear engaging portion 192. The gear portion 190 comprises a plurality of teeth. The gear engaging portion 192 is fixed to the gear portion 190. The gear engaging portion 192 projects rearward from the gear portion 190. An outer shape of the gear engaging portion 192 has a substantially cross shape. As shown in FIG. 13, the gear engaging portion 192 has a gear engaging hole 194. The gear engaging hole 194 penetrates the gear engaging portion 192 in the front-rear direction. The gear engaging hole 194 has a shape corresponding to an outer shape of the engaging portion 170 of the direction changing member 160. Due to this, the gear engaging hole 194 has a hole shape defined by a columnar-shaped hole and a cross-shaped hole being connected. As shown in FIG. 14, the engaging portion 170 is inserted into the gear engaging hole 194. The engaging portion 170 engages with the gear engaging portion 192 within the gear engaging hole 194. Due to this, the direction changing member 160 rotates integrally with the gear 180. The gear engaging portion 192 is fixed to the engaging portion 170 by a screw 196 in a state of being engaged with the engaging portion 170.

As shown in FIG. 11, the positioning member 182 is supported by the first gear 187b. The positioning member 182 comprises a first positioning engaging portion 198, a flange portion 200, a second positioning engaging portion 202, and a positioning portion 204.

The first positioning engaging portion 198 has a substantially cylindrical shape. As shown in FIG. 13, the first positioning engaging portion 198 has a positioning engaging hole 208. The positioning engaging hole 208 penetrates the first positioning engaging portion 198 in the front-rear direction. The positioning engaging hole 208 has a shape corresponding to an outer shape of the gear engaging portion 192 of the first gear 187b. Due to this, the positioning engaging hole 208 has a substantially cross shape. As shown in FIG. 14, the gear engaging portion 192 is inserted into the positioning engaging hole 208. The gear engaging portion 192 engages with the first positioning engaging portion 198 within the positioning engaging hole 208. Due to this, the positioning member 182 rotates about a positioning rotation axis AX7 integrally with the first gear 187b.

As shown in FIG. 11, the flange portion 200 is fixed to a rear end of the first positioning engaging portion 198. The flange portion 200 projects radially outward from an outer peripheral surface of the first positioning engaging portion 198. The flange portion 200 surrounds entirely the outer peripheral surface of the first positioning engaging portion 198. As shown in FIG. 12, the biasing member 186 is sandwiched between the flange portion 200 and an inner surface of the second front housing 84. The flange portion 200 is biased frontward toward the first gear 187b by the biasing member 186. Due to this, the positioning member 182 is biased toward the first gear 187b. Also, the positioning member 182 is configured to slide relative to the first gear 187b in the front-rear direction.

As shown in FIG. 11, the second positioning engaging portion 202 is fixed to a rear end of the flange portion 200. The second positioning engaging portion 202 comprises a columnar portion 212 extending from the flange portion 200 and a rib portion 214 extending from the columnar portion 212. As shown in FIG. 12, the rib portion 214 engages with the handle 184. The second positioning engaging portion 202 is fixed to the handle 184 by a screw 216. Due to this, the positioning member 182 moves integrally with the handle 184.

As shown in FIG. 11, the positioning portion 204 comprises a positioning base 220 and a positioning projection 222. The positioning base 220 extends upward from an outer peripheral surface of the first positioning engaging portion 198. The positioning projection 222 projects frontward from an upper part of a front surface of the positioning base 220.

As shown in FIG. 12, the handle 184 is supported by the second front housing 84. The handle 184 is configured to slide in the front-rear direction and also pivot about a handle pivot axis AX8. The handle pivot axis AX8 extends in the front-rear direction. A direction in which the handle pivot axis AX8 extends is the same as a sliding direction in which the handle 184 slides. The handle pivot axis AX8 is coaxial with the positioning rotation axis AX7. The handle 184 is operated by the user. The user pulls the handle 184 rearward toward the user while standing behind the front unit 64. Due to this, the user can easily operate the handle 184. When the handle 184 is pulled, the positioning member 182 slides rearward relative to the first gear 187b such that the positioning member 182 separates away from the first gear 187b. Also, the handle 184 pivots integrally with the positioning member 182.

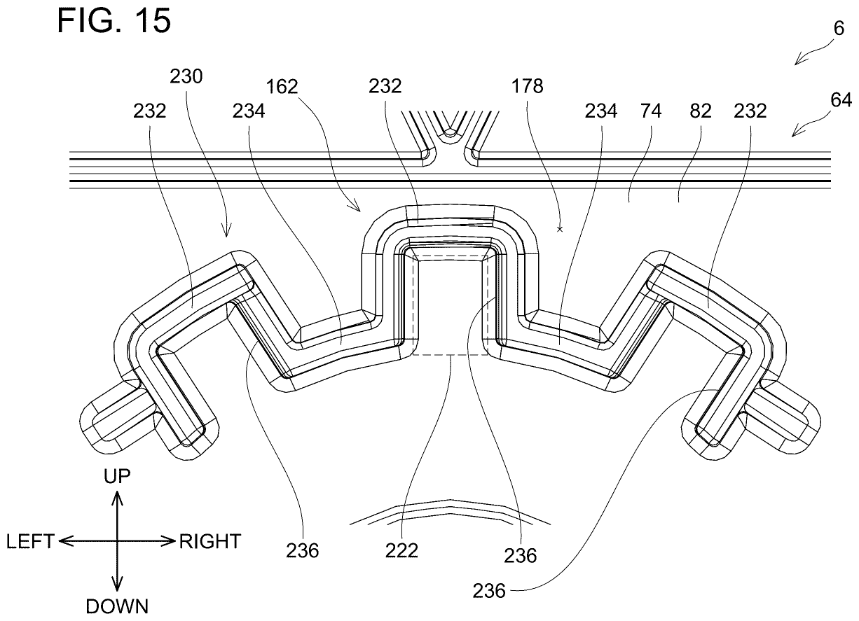

As shown in FIG. 15, the adjuster 162 further comprises a positioning rib 230. The positioning rib 230 is disposed in the gear accommodating space 178. The positioning rib 230 projects rearward from an inner surface of the first front housing 82. The positioning rib 230 comprises a plurality of (three in the present embodiment) U-shaped ribs 232 and connecting ribs 234 connecting the two adjacent U-shaped ribs 232.

Each of the three U-shaped ribs 232 defines a positioning groove 236. The three positioning grooves 236 are arranged apart from each other. Each of the positioning grooves 236 is configured to receive the positioning projection 222. The positioning rib 230 is configured to engage with the positioning projection 222 within each of the positioning grooves 236. In FIG. 15, the positioning projection 222 is shown by a broken line.

As shown in FIG. 12, when the handle 184 is not operated, the positioning member 182 is pressed against the first gear 187b by the biasing force of the biasing member 186. In this state, the positioning projection 222 is received by one of the positioning grooves 236. Hereafter, the state of the positioning projection 222 at this occasion may be referred to as a reception state. In this state, the positioning projection 222 engages with the positioning rib 230. Due to this, the positioning member 182 cannot pivot about the positioning rotation axis AX7. Further, in this state, the first positioning engaging portion 198 engages with the gear engaging portion 192 of the first gear 187b.

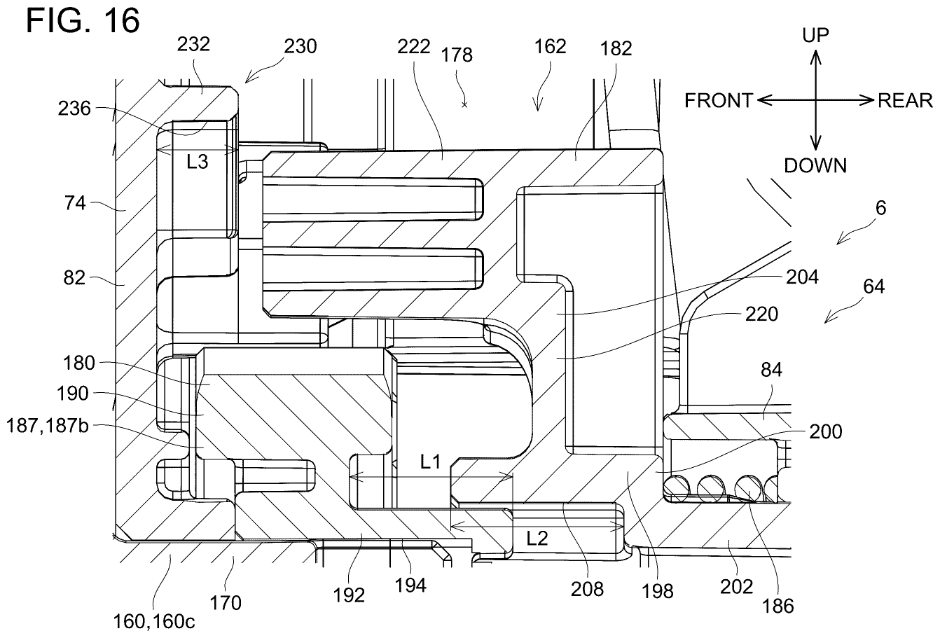

As shown in FIG. 16, when the handle 184 (see FIG. 12) is pulled rearward toward the user by a predetermined distance, the positioning member 182 slides rearward relative to the first gear 187b such that the positioning member 182 separates away from the first gear 187b, by which the positioning projection 222 detaches from the positioning groove 236. Due to this, the positioning projection 222 is switched from the reception state to a non-reception state in which the positioning projection 222 is not received by the positioning grooves 236. In this state, the positioning projection 222 does not engage with the positioning rib 230. In the present embodiment, both of a length L1 of the gear engaging portion 192 of the first gear 187b in the front-rear direction and a length L2 of the first positioning engaging portion 198 in the front-rear direction are longer than a length L3 of the positioning grooves 236 in the front-rear direction. Due to this, even when the positioning projection 222 is switched from the reception state to the non-reception state, the first positioning engaging portion 198 engages with the gear engaging portion 192 of the first gear 187b. Due to this, the positioning member 182 can pivot about the positioning rotation axis AX7 integrally with the first gear 187b. The length L1 is substantially the same as the length L2. As shown in FIG. 12, when the positioning projection 222 is in the reception state, an entire area of the first positioning engaging portion 198 in the front-rear direction engages with the gear engaging portion 192 of the first gear 187b. Due to this, a length in the front-rear direction of an area in which the first positioning engaging portion 198 and the gear engaging portion 192 overlap is longer than the length L3 (see FIG. 16) of the positioning grooves 236.

When the orientation of the direction changing members 160 is to be changed, as shown in FIG. 16, firstly, the user pulls the handle 184 rearward toward the user. The positioning projection 222 is switched from the reception state to the non-reception state by the positioning member 182 sliding rearward. Next, the user pivots the handle 184 in a desired direction about the handle pivot axis AX8 (see FIG. 12) with the handle 184 pulled toward the user. The first gear 187b pivots accompanying with the pivoting of the positioning member 182, by which the five gears 180 pivot. Due to this, the orientations of the three direction changing members 160 are changed simultaneously. Lastly, the user releases the handle 184. The positioning member 182 slides frontward by the biasing force of the biasing member 186 such that the positioning member 182 separates away together with the handle 184 from the user. Due to this, the positioning projection 222 is switched from the non-reception state to the reception state. Due to this, the positioning projection 222 engages with the positioning rib 230. As a result of this, the orientation of the direction changing members 160 is fixed. In the present embodiment, the orientations of the direction changing members 160 can be changed in three patterns. In a modification, the orientation of the direction changing members 160 may be changed in two patterns, or may be changed in four or more patterns.

### (Effects)

The working machine 2 in the present embodiment comprises the operation rod 68 extending in the front-rear direction, the rear unit 14 disposed at the rear end of the operation rod 68 and comprising the motor 26 (one example of “prime mover”), and the front unit 64 disposed at the front end of the operation rod 68. The front unit 64 comprises the front housing 74, the first member 112 disposed within the front housing 74 and fixed to the front housing 74, the working shaft 104 (one example of “first shaft”) that is rotatable and supported by the first member 112 via the first bearing 128, the working member 106 configured to work by rotation of the working shaft 104, and the transmission unit 76 configured to rotate the working shaft 104 when the motor 26 operates. The transmission unit 76 comprises the transmission shaft 90 (one example of “second shaft”) supported by the first member 112 via the second bearing 132, the front pulley 98 (one example of “first pulley”) fixed to the working shaft 104 and configured to rotate about the front pulley rotation axis AX5 (one example of “first pulley rotation axis”), the rear pulley 96 (one example of “second pulley”) fixed to the transmission shaft 90 and configured to rotate about the rear pulley rotation axis AX4 (example of “second pulley rotation axis”) substantially parallel to the front pulley rotation axis AX5, and the belt 100 connecting the front pulley 98 and the rear pulley 96.

According to the configuration, the working shaft 104 and the transmission shaft 90 are both supported by the first member 112. Due to this, the position of the transmission shaft 90 relative to the working shaft 104 can be suppressed from changing. Due to this, suitable tension can be applied to the belt 100 when the belt 100 is connected to the front pulley 98 and the rear pulley 96. Due to this, a tensioner can be omitted.

The attachment 6 in the present embodiment is attached to the base unit 4 including the rear operation rod 10 extending in the front-rear direction and the rear unit 14 disposed at the rear end of the rear operation rod 10 and including the motor 26 (one example of “prime mover”). The attachment 6 comprises the front operation rod 60 extending in the front-rear direction and attached to the rear operation rod 10, and the front unit 64 disposed at the front end of the front operation rod 60. The front unit 64 comprises the front housing 74, the first member 112 disposed within the front housing 74 and fixed to the front housing 74, the working shaft 104 (one example of “first shaft”) that is rotatable and supported by the first member 112 via the first bearing 128, the working member 106 configured to work by rotation of the working shaft 104, and the transmission unit 76 configured to rotate the working shaft 104 when the motor 26 operates. The transmission unit 76 comprises the transmission shaft 90 (one example of “second shaft”) supported by the first member 112 via the second bearing 132, the front pulley 98 (one example of “first pulley”) fixed to the working shaft 104 and configured to rotate about the front pulley rotation axis AX5 (one example of “first pulley rotation axis”), the rear pulley 96 (one example of “second pulley”) fixed to the transmission shaft 90 and configured to rotate about the rear pulley rotation axis AX4 (example of “second pulley rotation axis”) substantially parallel to the front pulley rotation axis AX5, and the belt 100 connecting the front pulley 98 and the rear pulley 96.

According to the above configuration, the same effect as that the above-mentioned working machine 2 brings can be achieved.

In addition, the working shaft 104 is substantially parallel to the transmission shaft 90.

According to the above configuration, configurations of the working shaft 104 and the transmission shaft 90 can be simplified.

In addition, the working machine 2 may further comprise the front rod shaft 62 (one example of “third shaft”) substantially perpendicular to the transmission shaft 90 and extending in the front-rear direction. The front rod shaft 62 is configured to rotate the transmission shaft 90 when the motor 26 operates.

According to the above configuration, the working shaft rotation axis AX6 of the working shaft 104 is substantially perpendicular to the operation rod 68. Due to this, workability by the working machine 2 can be improved.

In addition, the front unit 64 comprises the second member 114 fixed to the first member 112 and surrounding the transmission shaft 90, and the third member 116 fixed to the second member 114 and the operation rod 68 and surrounding the front rod shaft 62. The transmission shaft 90 is supported by the third member 116 via the third bearing 146.

According to the above configuration, the position of the transmission shaft 90 relative to the working shaft 104 can be suppressed from being changed.

In addition, one end of the working shaft 104 is supported by the front housing 74.

According to the above configuration, vibration of the working shaft 104 caused by rotation of the working shaft 104 can be suppressed as compared to a configuration where the one end of the working shaft 104 is not supported.

In addition, the first member 112 is constituted of metal.

According to the above configuration, the first member 112 can be suppressed from being deformed as compared to a configuration where the first member 112 is constituted of a resin material. Due to this, the position of the transmission shaft 90 relative to the working shaft 104 can be farther suppressed from being changed.

### (Modifications)

The working machine 2 in an aspect may not be a snow remover, but may be for example, a power brush, a power sweeper, a tiller, or a dethatcher.

In an aspect, the orientation of the direction changing members 160 may be changed by an actuator (not shown).

In an aspect, the handle 184 may pivot about the handle pivot axis AX8 in a state of being pressed in frontward. When the handle 184 is pressed in frontward, the positioning projection 222 is in the non-reception state. By the positioning member 182 pivoting about the positioning rotation axis AX7, the plurality of gears 180 rotates.

In an aspect, the shapes of the first gears 187 may be different from the shapes of the second gears 188.

In an aspect, the rotational centers of the second gears 188 may not be arranged on a line connecting the rotational centers of the plurality of first gears 187.

The working machine 2 in an aspect may comprise an engine (not shown) instead of the motor 26.

The transmission shaft 90 in an aspect may be a flexible shaft which can bend. In this configuration, the transmission shaft 90 is rotatable in the bended state. The transmission shaft 90 may be curved, for example, 90 degrees.

The working shaft 104 in an aspect may be inclined relative to the transmission shaft 90.

In an aspect, the working shaft 104 and the working member 106 may be a component which is fabricated by integral molding.

What is claimed is:

1. A working machine, comprising:
an operation rod extending in a front-rear direction;
a rear unit disposed at a rear end of the operation rod and comprising a prime mover; and
a front unit disposed at a front end of the operation rod,
wherein the front unit comprises:
a front housing;
a first member disposed within the front housing and fixed to the front housing;
a first shaft that is rotatable and supported by the first member via a first bearing;
a working member configured to work by rotation of the first shaft; and
a transmission unit configured to rotate the first shaft when the prime mover operates,
wherein the transmission unit comprises:
a second shaft supported by the first member via a second bearing;
a first pulley fixed to the first shaft and configured to rotate about a first pulley rotation axis;
a second pulley fixed to the second shaft and configured to rotate about a second pulley rotation axis substantially parallel to the first pulley rotation axis; and
a belt connecting the first pulley and the second pulley.

2. The working machine according to claim 1, wherein the first shaft is substantially parallel to the second shaft.

3. The working machine according to claim 1, further comprising
a third shaft substantially perpendicular to the second shaft and extending in the front-rear direction,
wherein the third shaft is configured to rotate the second shaft when the prime mover operates.

4. The working machine according to claim 3, wherein the front unit comprises:
a second member fixed to the first member and surrounding the second shaft; and
a third member fixed to the second member and the operation rod and surrounding the third shaft,
wherein the second shaft is supported by the third member via a third bearing.

5. The working machine according to claim 1, wherein one end of the first shaft is supported by the front housing.

6. The working machine according to claim 1, wherein the first member is constituted of metal.

7. An attachment attached to a base unit including a rear operation rod extending in a front-rear direction and a rear unit disposed at a rear end of the rear operation rod and including a prime mover, the attachment comprising:
a front operation rod extending in the front-rear direction and attached to the rear operation rod; and
a front unit disposed at a front end of the front operation rod,
wherein the front unit comprises:
a front housing;
a first member disposed within the front housing and fixed to the front housing;
a first shaft that is rotatable and supported by the first member via a first bearing;
a working member configured to work by rotation of the first shaft; and
a transmission unit configured to rotate the first shaft when the prime mover operates,
wherein the transmission unit comprises:
a second shaft supported by the first member via a second bearing;
a first pulley fixed to the first shaft and configured to rotate about a first pulley rotation axis;
a second pulley fixed to the second shaft and configured to rotate about a second pulley rotation axis substantially parallel to the first pulley rotation axis; and
a belt connecting the first pulley and the second pulley.

8. The working machine according to claim 2, further comprising:
a third shaft substantially perpendicular to the second shaft and extending in the front-rear direction,
wherein the third shaft is configured to rotate the second shaft when the prime mover operates,
wherein the front unit comprises:
a second member fixed to the first member and surrounding the second shaft; and
a third member fixed to the second member and the operation rod and surrounding the third shaft,
wherein the second shaft is supported by the third member via a third bearing,
wherein one end of the first shaft is supported by the front housing,
wherein the first member is constituted of metal.
